(19) United States
(12) Patent Application Publication
(10) Pub. No.: US 2026/0227961 A1
(43) Pub. Date: Aug. 6, 2026

(54) DETECTING AND ADDRESSING POWER SIDE CHANNELS IN SEMICONDUCTOR ARCHITECTURE AND MICROARCHITECHTURE

(71) Applicant: International Business Machines Corporation, Armonk, NY (US)

(72) Inventors: Naorin Hossain, Secaucus, NJ (US); Ramon Bertran Monfort, New Orleans, LA (US); William Santiago-Fernandez, Hopewell Junction, NY (US); Alper Buyuktosunoglu, White Plains, NY (US); Pradip Bose, YORKTOWN HEIGHTS, NY (US)

(73) Assignee: International Business Machines Corporation, Armonk, NY (US)

(21) Appl. No.: 19/044,835

(22) Filed: Feb. 4, 2025

(51) Int. Cl. G06F 8/30

(52) U.S. Cl. CPC G06F 8/30

(57) ABSTRACT

An embodiment includes determining a power side channel of the hardware representative system. The embodiment includes constructing a power consumption relation based in part on the instruction. The embodiment includes generating executable code based on the power consumption relation wherein an output of executing the executable code comprises the power side channel of the hardware representative system. The embodiment includes extracting a power consumption result of the instruction of the hardware representative system according to an output of executing code based on a power consumption relation of the instruction. The embodiment also includes adjusting an architecture and a microarchitecture of the hardware representative system according to the power leakage metric.

### BACKGROUND

The present invention relates generally to semiconductors. More particularly, the present invention relates to a method, system, and computer program for Detecting and Addressing Power Side Channels in Semiconductor Architecture and Microarchitecture.

Modern electronics, from the smartphone to the autonomous features of cutting-edge vehicles, are all made possible by semiconductors that sit at the heart of all modern electronic devices, integrated circuits, and specialized components. Some chips contain up to billions of semiconductor devices spread across a silicon wafer. The process of designing and fabricating a semiconductor chip is highly specialized and expensive.

Many attacks have occurred that exploit side-effects of program execution to expose secret information and many proposed countermeasures to protect against these attacks. A side channel attack (SCA) is a security exploit that attempts to extract secrets from a chip or a system. This can be achieved by measuring or analyzing various physical parameters. Examples include supply current, execution time, and electromagnetic emission. These attacks pose a serious threat to modules that integrate cryptographic systems, a side channel attack attempts to gather information or influence the program execution of a system by measuring or exploiting indirect effects of the system or its hardware.

### SUMMARY

The illustrative embodiments provide for Detecting and Addressing Power Side Channels in Semiconductor Architecture and Microarchitecture. An embodiment includes determining a power consumption result of a hardware representative system. The embodiment includes constructing a power consumption relation based in part on an instruction. The embodiment also includes generating executable code based on the power consumption relation where an output of executing the executable code comprises the power consumption result of the hardware representative system.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

An embodiment includes determining a power leakage metric of a hardware representative system. The embodiment includes extracting a power consumption result of an instruction of the hardware representative system according to an output of executing code based on a power consumption relation of the instruction. The embodiment also includes determining the power leakage metric according to a correlation between the power consumption result and a reference metric.

An embodiment includes determining a power leakage metric of a hardware representative system. The embodiment includes extracting a power consumption result of an instruction of the hardware representative system based on an output of executing code based on a power consumption relation of the instruction. The embodiment includes determining the power leakage metric according to a correlation between the power consumption result and a reference metric. The embodiment also includes adjusting an architecture and a microarchitecture of the hardware representative system according to the power leakage metric.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a diagram of a power-based side channel of a device in an environment in accordance with an illustrative embodiment;

FIG. 3 depicts a diagram of a power-based side channel leakage in an environment in accordance with an illustrative embodiment;

FIG. 4 depicts a diagram of constructing a formal construct of a power consumption relation in an environment in accordance with an illustrative embodiment;

FIG. 5A depicts a diagram of an example power consumption relation of RSA encryption in an environment in accordance with an illustrative embodiment;

FIG. 5B depicts a diagram of an example microarchitectural power consumption change in an environment in accordance with an illustrative embodiment;

FIG. 6 depicts a flow chart of an example process for determining power side channels in semiconductor architecture and microarchitecture in an environment in accordance with an illustrative embodiment; and

FIG. 7 depicts a system diagram that illustrates an example system for determining power side channels in semiconductor architecture and microarchitecture system in accordance with an illustrative embodiment.

### DETAILED DESCRIPTION

Semiconductor devices are used for diodes, transistors, memory, processors and system on a chip (SoC). An instruction set architecture (ISA) defines the set of basic operations a computer must support. This includes the functional definition of operations and precise descriptions of how to invoke and access them. An ISA is independent from microarchitecture, which refers to the implementation of an ISA in a device. Architecture informs what the operation of a processor is. Microarchitecture informs how a processor performs the operations required by the architecture. A single ISA can have different microarchitecture implementations.

Power side channels are inherent to semiconductor system design. Power side channel attacks exploit the correlation between a device's power consumption and the operations it is performing of the instructions and/or operands. The attacker monitors the device's power consumption to learn about the data being processed. Side channel attacks (SCA) are a type of cyber-attack that exploit these side channels to steal information. SCAs are noninvasive attacks that target the implementation of a cryptographic algorithm. This type of attack looks for information that might inadvertently leak from a device while operating. SCAs can extract sensitive information without directly interacting with the system's code or data. The attacker can then use this information to extract cryptographic keys or other sensitive information.

Several power side channel patching ideas are known but expensive to implement in post-silicon stages of design or after fabrication. Moreover, previous work focused on discovery of power side channels and mitigation but do not evaluate base design itself for potential side channels. There is currently no systematic, holistic methodology for understanding information leakage. As a result, it is not well known how to determine power side channels at an early stage and to adjust design decisions that affect information leakage or the vulnerability of systems to side channel attacks.

The following description provides examples of embodiments of the present disclosure, and variations and substitutions may be made in other embodiments. Several examples will now be provided to further clarify various aspects of the present disclosure.

Example 1: A computer-implemented method that comprises determining, a power consumption result of the hardware representative system. The method further comprises constructing a power consumption relation based in part on the instruction. The method further comprises generating executable code based on the power consumption relation wherein an output of executing the executable code comprises the power consumption result of the hardware representative system.

The above limitations advantageously enable automated evaluation of power side channel vulnerability of a semiconductor device at an early design stage to enable adjusting the microarchitecture and architecture to address the power side channel vulnerability. The above limitations advantageously enable a construction of formal power consumption relations to specify architectural and microarchitectural power consumption changes to formalize and automate analysis for probable power side channel leakage cases. The above limitations also advantageously enable automated test case generation based on a formal model to ensure comprehensive testing.

The term “hardware representative system” as used herein, and without implying any limitation thereto, may refer to a representation of a semiconductor hardware. The term “hardware” as used herein and without implying any limitation thereto, may refer to a semiconductor device, circuit, chip or equivalent on which instructions and/or operands are executed. The hardware representative system may be constructed from standard, well-known techniques including combining standard module interfaces and buses, small amounts of glue logic, and I/O buffers to connect the devices into a single hardware system description.

The term “a power consumption relation” as used herein, and without implying any limitation thereto, may refer to a relationship of a semiconductor device's instruction and/or operand to a power consumption, that is, the amount of power a device uses performing the instruction and/or operand.

The term “power consumption result” as used herein, and without implying any limitation thereto, may refer to a passage of information that correlates between a semiconductor device's power consumption and the operations it is performing.

Example 2: The limitations of Example 1, where the power consumption relation is based on a power consumption difference during an operand change.

The above limitations advantageously enable a construction of formal power consumption relations to specify architectural and microarchitectural power consumption changes at an operand level to formalize and automate analysis for probable power side channel leakage cases. Additionally, the limitations realize the benefits described with respect to Example 1.

Example 3: The limitations of Example 1, where constructing the power consumption relation comprises a power consumption relation according to a microarchitecture of a hardware system.

The above limitations advantageously enable a construction of formal power consumption relations to specify microarchitectural power consumption changes at an operand level to formalize and automate analysis for probable power side-leakage cases. Additionally, the limitations realize the benefits described with respect to Examples 1-2.

Example 4: The limitations of Example 1, where the hardware representative system represents a pre-silicon system and wherein the executable code is used to adjust the design of a hardware represented by the hardware representative system.

The above limitations advantageously enable automated evaluation of power side channel vulnerability at early, pre-silicon design stages to enable modifying microarchitecture and architecture to address the power side channel vulnerability before fabrication. Additionally, the limitations realize the benefits described with respect to Examples 1-3.

The term “pre-silicon system” as used herein, and without implying any limitation thereto, may refer to a semiconductor system before fabrication on silicon and/or in the initial stages of fabrication. The term contrasts with post-silicon which may mean a fully fabricated system.

Example 5: The limitations of Example 1, where generating executable code uses a Boolean satisfiability solver to generate the executable code wherein the executable code is a counterexample that determines whether a power side channel of the hardware representative system exists.

The above limitations advantageously enable the generation of executable code that is a counterexample that is executable by the system to determine the power side channel the hardware representative system. Additionally, the limitations realize the benefits described with respect to Examples 1-4.

The term “counterexample” as used herein, and without implying any limitation thereto, may refer to probabilistic software code or an algorithm to identify errors and prove limitations.

Example 6: The limitations of Example 1, where the power consumption result outputted by executing the executable code comprises a power consumption of an architecturally defined instruction.

The above limitations advantageously enable a power consumption of an architecturally defined instruction to formalize and automate analysis for probable power side channel leakage cases at the architectural level. Additionally, the limitations realize the benefits described with respect to Examples 1-5.

Example 7: The limitations of Example 1, further comprising constructing power consumption relation according to an operand of the instruction.

The above limitations advantageously enable a determination of a power side channel of the hardware representative system to comprise a power consumption relation according to an operand of the instruction. Additionally, the limitations realize the benefits described with respect to Examples 1-6.

Example 8: A computer program product comprising one or more computer readable storage media, and program instructions collectively stored on the one or more computer readable storage media, the program instructions executable by a processor to cause the processor to perform the method according to any of Examples 1-7. The computer program product of Example 6 realizes the benefits described with respect to Examples 1-7. The computer program product of Example 6 can advantageously be implemented into a variety of computer program products.

Example 9: A computer system comprising a processor and one or more computer readable storage media, and program instructions collectively stored on the one or more computer readable storage media, the program instructions executable by the processor to cause the processor to perform the method according to any of Examples 1-7. The computer system of Example 9 realizes the benefits described with respect to Examples 1-7. The computer system of Example 9 can advantageously be implemented into a variety of computer devices.

Example 10: A computer-implemented method that comprises responsive to detecting an instruction of a hardware representative system, determining a power leakage metric of the hardware-representative system comprising. The method further comprises extracting a power consumption result of the instruction of the hardware representative system according to an output of executing code based on a power consumption relation of the instruction. The method further comprises determining the power leakage metric according to a correlation between the power consumption result and a reference metric. The above limitations realize the technical benefits described with respect to Examples 1-7.

Example 11: A computer-implemented method that comprises responsive to detecting an instruction of a microarchitecture of a hardware representative system, determining a power leakage metric of the hardware-representative system. The method further comprises extracting a power consumption result of the instruction of the hardware representative system based on an output of executing code based on a power consumption relation of the instruction. The method further comprises determining the power leakage metric according to a correlation between the power consumption result and a reference metric. The method further comprises adjusting an architecture and a microarchitecture of the hardware representative system according to the power leakage metric. The above limitations realize the technical benefits described with respect to Examples 1-7.

Example 12: A computer-implemented method that comprises determining a power side channel of the hardware representative system. The method further comprises responsive to detecting an instruction of a hardware representative system. The method further comprises constructing a power consumption relation based in part on the instruction. The method further comprises generating executable code based on the power consumption relation wherein an output of executing the executable code comprises the power side channel of the hardware representative system. The method further comprises extracting a power consumption result of the instruction of the hardware representative system based on an output of executing code based on a power consumption relation of the instruction. The method further comprises determining the power leakage metric according to a correlation between the power consumption result and a reference metric. The method further comprises adjusting an architecture and a microarchitecture of the hardware representative system according to the power leakage metric. The above limitations realize the technical benefits described with respect to Examples 1-7.

Aspects of the present disclosure can be implemented in a variety of technical use cases. The following use cases are merely exemplary and are not intended to limit the scope of the disclosure.

In a use case, the power side channel of a hardware representation of a semiconductor device to perform Rivest-Shamir-Adleman (RSA) encryption is determined. The system determines a power side channel of the hardware representative system comprising constructing a power consumption relation based in part on the instruction; and generating executable code based on the power consumption relation wherein an output of executing the executable code comprises the power side channel of the hardware representative system.

In another use case, a power leakage metric of a hardware representation of a semiconductor device to perform RSA encryption, prior to fabrication, that is, at the pre-silicon stage. The system determines a power leakage metric of the hardware representative system comprising extracting a power consumption result of the instruction of the hardware representative system based on an output of executing code based on a power consumption relation of the instruction; and generating executable code based on the power consumption relation wherein an output of executing the executable code comprises the power side channel of the hardware representative system.

In another use case, an architecture and the microarchitecture of a hardware representation of a semiconductor device to perform RSA encryption is determined and is adjusted according to the power leakage metric of the hardware representation, of a semiconductor device. Responsive to detecting an instruction of the device, the system determines, a power leakage metric of the hardware representative system comprising extracting a power consumption result of the instruction of the hardware representative system based on an output of executing code based on a power consumption relation of the instruction; and generating executable code based on the power consumption relation wherein an output of executing the executable code comprises the power side channel of the hardware representative system. The design of the semiconductor device is adjusted according to the power leakage metric, for example, adding noise to make power consumption appear the same between multiply and square operands, including a temporary register that is populated with new value that counteracts Hamming distance changes in the operands, adding noise to an Arithmetic Logic Unit (ALU) when instruction queue indicates order that will lead to power changes, and/or pre-fetching operation to avoid cache misses so that power consumption does not change between hits and misses.

The present disclosure provides for a method, a machine-readable medium, and a system for Detecting and Addressing Power Side Channels in Semiconductor Architecture and Microarchitecture.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

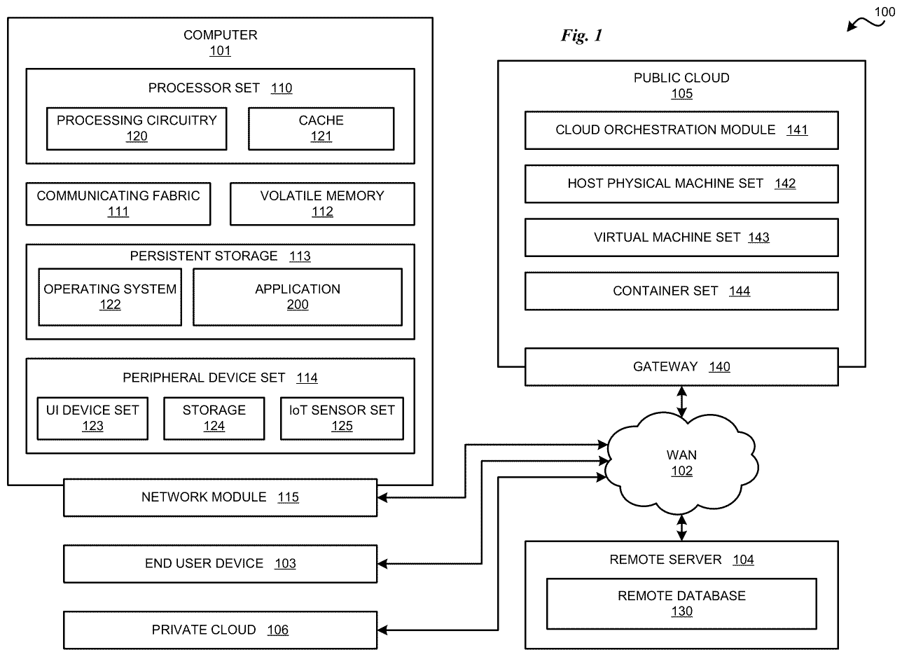

With reference to FIG. 1, this figure depicts a block diagram of a computing environment 100. Data center environment 100 contains an example of an environment for the execution of at least some of the computer code involved in performing the inventive methods, such as an Application module 200 that provides Detecting and Addressing Power Side Channels in Semiconductor Architecture and Microarchitecture. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made. Available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of Application Programming Interfaces (API). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

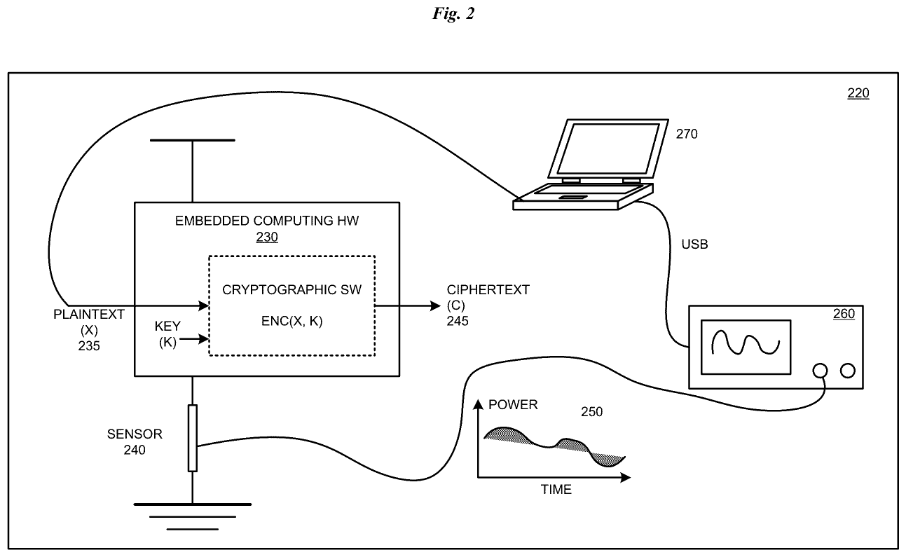

FIG. 2 depicts a diagram of a power-based side channel of a device in an environment in accordance with an illustrative embodiment. In a particular embodiment, the components of the diagram 220 show aspects of the Application 200 of FIG. 1.

In the illustrated embodiment, a semiconductor device 230, receives a plaintext 235 from a client device 270. The semiconductor outputs a ciphertext 245 which may cause either current draw or fluctuations in voltage 250 that are detected by a sensor 240 and monitored by a power monitoring device 260. For example, the power consumed by the device will vary according to the activity of the individual transistors and the instructions operating in the transistors. The power consumption of an IC is a side channel. It contains leakage information about what is happening inside of the IC, what data is being processed, and what operations are being performed.

In embodiments, a hardware representative system comprises a representation of a system hardware description to produce a physical system. In some examples, a hardware representative system may also comprise a software tool that may consist of conventional logic synthesis tools, layout tools, and fabrication tools that take the hardware description language (HDL) hardware system description and produces a physical design in the form of a semiconductor chip or multiple semiconductor chips. The system tool may also consist of conventional schematic capture tools, netlist tools, layout tools, fabrication tools, and assembly tools that take the schematic hardware system description and produce a physical design in the form of a printed circuit board populated with semiconductor chips.

The hardware representative system may be constructed from standard, well-known techniques including combining standard module interfaces and buses, small amounts of glue logic, and I/O buffers to connect the devices into a single hardware system description. The processor and device descriptions are combinations of HDL descriptions and hard pre-designed and pre-verified components used in the creation of semiconductor chips or integrated circuits (ICs) cores representing physical layouts on a chip.

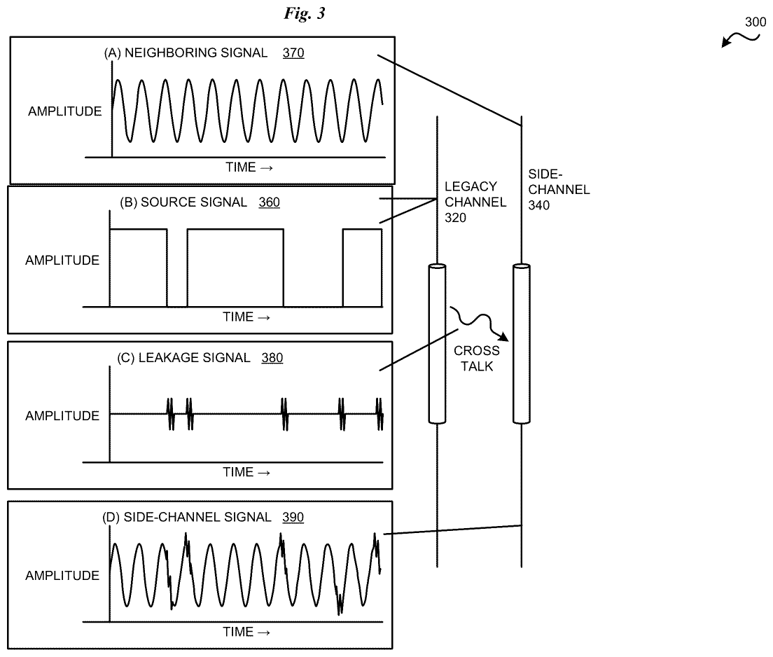

FIG. 3 depicts a diagram of a power-based side channel leakage in an environment in accordance with an illustrative embodiment. In a particular embodiment, the components of the diagram 300 show aspects of the Application 200 of FIG. 1.

In the illustrated embodiment, a source signal 360 is input into the legacy channel 320 of a semiconductor device such as described above in 230. A leakage signal 380, for example, resulting from the device performing an ISA operation is leaked from the device. In some embodiments, an adjacent side channel 340 receives a neighboring signal 370, the source signal 360 propagates through to the adjacent side channel 340 due to a radiation phenomenon, resulting in a leak in the adjacent side channel 340. As can be seen from the side channel signal power trace 390, certain operations consume more power, which results in a taller spike in the power trace.

In embodiments, a microarchitecture of a semiconductor device, also known as computer organization, refers to the structure and design of a computer's central processing unit (CPU) or other hardware components. It encompasses the internal organization, data paths, memory hierarchy, and control units of a computer system. The main components of microarchitecture include the arithmetic logic unit (ALU), control unit, registers, memory management unit (MMU), cache hierarchy, and interconnects. These components work together to execute instructions, perform calculations, manage data, and control the flow of information within the processor. The design choices made in microarchitecture significantly impact power consumption. Techniques such as clock gating, dynamic voltage scaling, and power gating are employed to reduce power consumption during idle periods, optimize energy usage, and enhance battery life in mobile devices.

In embodiments, an Instruction Set Architecture (ISA) is a machine instruction that a computer's processor can execute that defines how the CPU is controlled. The ISA acts as an interface between the hardware and the software, specifying both what the processor is capable of doing as well as how it gets done. The ISA may provide the only way through which a user is able to interact with the hardware. It can be viewed as a programmer's manual because it's the portion of the machine that's visible to the assembly language programmer, the compiler writer, and the application programmer.

The ISA defines the supported data types, the registers, how the hardware manages main memory, key features (such as virtual memory), which instructions a microprocessor can execute, and the input/output model of multiple ISA implementations. The ISA can be extended by adding instructions or other capabilities, or by adding support for larger addresses and data values.

In embodiments, executing a single instruction by a central processing unit (CPU) consists of a particular cycle of events; fetching, decoding, executing and storing. For example, to do the add instruction the CPU must fetch: get the instruction from memory into the processor; decode: internally decode the operation (in this case add); execute: take the values from the registers, and then add them together; and Store: store the result back into another register.

Factors Affecting Power Consumption: Instruction Complexity: Complex instructions requiring multiple operations within a single stage can draw more power. Data Dependencies: when an instruction needs to wait for the result of a previous instruction, it can lead to pipeline stalls and increased power usage. Cache Accesses: accessing data from the cache can have different power implications compared to accessing main memory. Functional Unit Utilization: the number of active functional units (like ALUs, multipliers) during an instruction execution impacts power consumption.

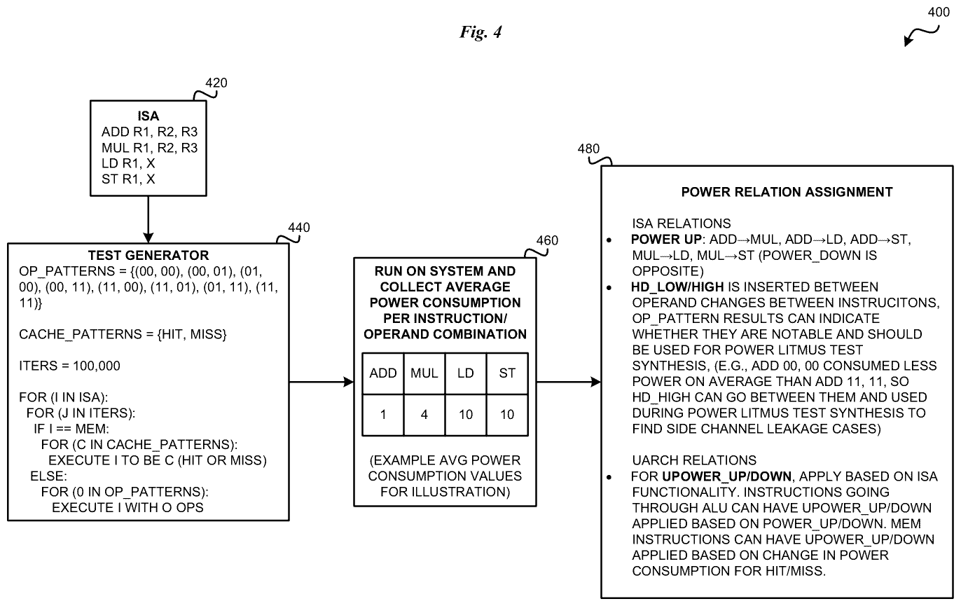

FIG. 4 depicts a diagram of constructing a formal construct of a power consumption relation in an environment in accordance with an illustrative embodiment. In a particular embodiment, the components of the diagram 400 show aspects of the Application 200 of FIG. 1.

In the illustrated embodiment, a power consumption profile for each ISA instruction 420 is determined using a variety of operands. Definitions are determined of power consumption relation placement rules 480 based on average power differences between instructions and operand changes 460. For example, for a test generated by test generator 440 of the ISA instructions, an average power consumption per instruction/operand is determined. In some examples, specialized hardware such as an integrated power monitoring features such as probes within the CPU itself are used to accurately measure power consumption in real-time. Benchmarking software may be used to run a controlled workload with a known number of instructions, allowing the calculation of power consumption per instruction. In this example, power relation assignments for ISA relations and microarchitecture relations may be performed. As shown, a power_up event (and power_down) may be inserted in some operations to represent power consumption of the operations. hd_low/high (Hamming distance low/high) is inserted between operand changes between instructions. An op_pattern result can indicate whether they are notable and should be used for power litmus test synthesis. (e.g., add 00, 00 consumed less power on average than add 11, 11, so hd_high can go between them and used during power litmus test synthesis to find side channel leakage cases). In embodiments, the formal construct of a power consumption relation of a semiconductor device is thereby achieved.

In embodiments, relations for specifying when power consumption changes occur at architectural and microarchitectural levels are defined as: power_up/power_down: power consumption change between architecturally defined instructions, hd_low/hd_high: Hamming distance between architecturally defined instruction operands, and upower_up/upower_down: power consumption changes between microarchitectural states of functional units.

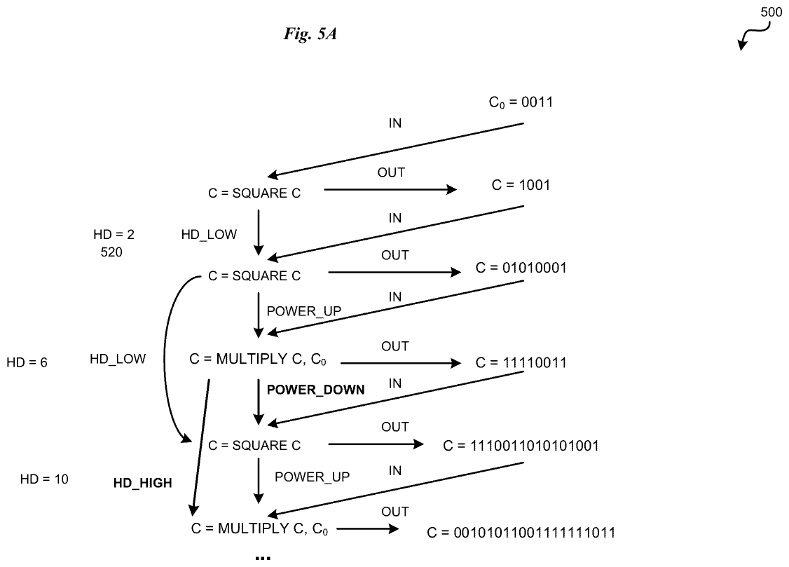

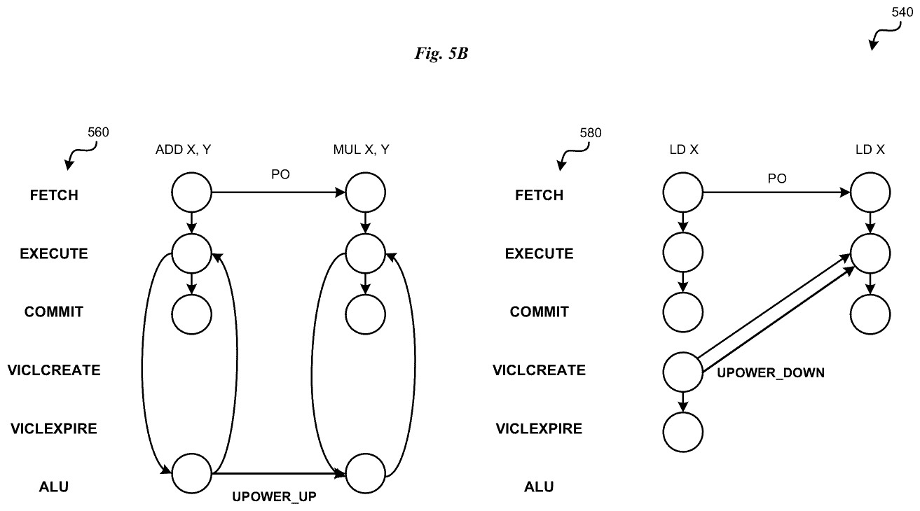

FIG. 5A depicts a diagram of an example power consumption relation of RSA encryption in an environment in accordance with an illustrative embodiment. In a particular embodiment, the components of the diagram 500 show aspects of the Application 200 of FIG. 1.

In the illustrated embodiment, an RSA encryption comprises square and multiply operations. For example, the power consumption changes between a square operation and multiply operation will comprise a power_up relation. A Hamming distance 520 (e.g. C₀=0011) changes in the operands are also shown relative to the power consumption changes.

FIG. 5B depicts a diagram of an example microarchitectural power consumption change in an environment in accordance with an illustrative embodiment. In a particular embodiment, the components of the diagram 540 show aspects of the Application 200 of FIG. 1.

In the illustrated embodiment, the left chart 560 depicts add and multiply operations in an Arithmetic Logic Unit (ALU) showing more power (upower_up) for a multiply operation. The right chart 580 shows two load operations (cache miss followed by a cache hit) which may result in a upower_down power consumption change.

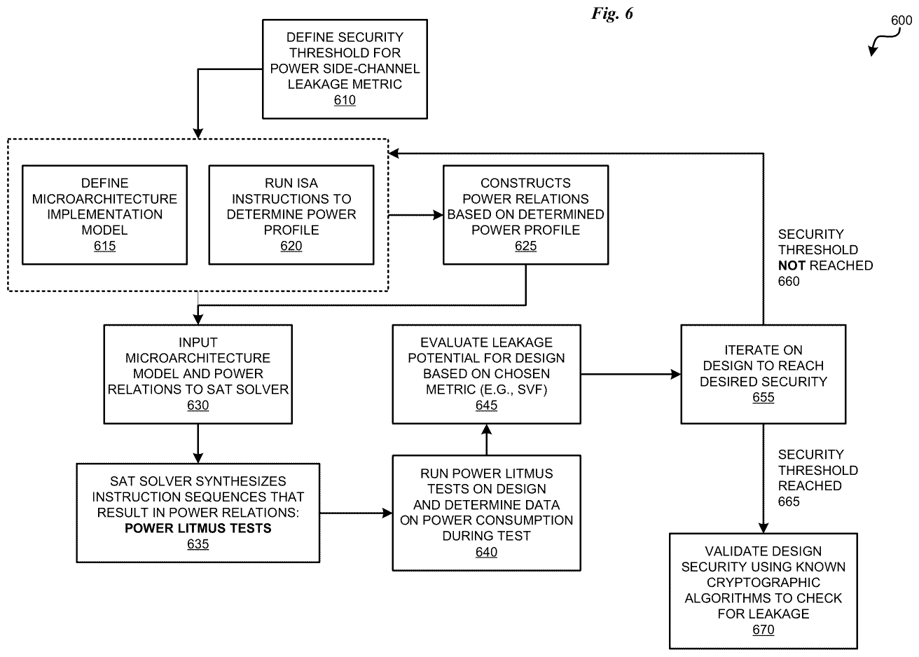

FIG. 6 depicts a flow chart of an example process for determining power side channels in semiconductor architecture and microarchitecture in an environment in accordance with an illustrative embodiment. In a particular embodiment, the components of the diagram 600 show aspects of the Application 200 of FIG. 1.

In the illustrated embodiment, at step 610, the system receives a security threshold for how much leakage via power side channels is acceptable for a given design. For example, the threshold may be defined according to a SVF metric as explained below or to user specified tolerance level. At step 615, using relational logic, define a model representative of an implementation of the microarchitecture design. Run each ISA instruction with a variety of operands to determine a power profile for each instruction at step 620. In some embodiments, the system may interface with a power sensor probe to determine the power consumption of an instruction and/or operand as well as power consumption changes as the instruction/operand is executed. For example, the system may initiate communications with a probe and query the probe for the power data. In another embodiment, the power consumption may be determined via a power proxy in a cycle-accurate simulator environment for the target system. At step 625, the system constructs the power relations for the design based on the determined instruction-level power profile.

At step 630, the microarchitecture and power relations are inputted into a known Boolean satisfiability (SAT) solver. The SAT solver synthesizes instruction sequences that result in power relations: power litmus tests at step 635. For example, in the context of circuits, SAT algorithms are used to perform a variety of automated reasoning and verification tasks. It works by guessing the value of a variable, for example, the power relations as explained above, propagating the effects of that guess, and backtracking if it realizes the problem cannot be satisfied with such a guess. A SAT solver synthesizer uses a SAT solver to implement circuit transformations in logic synthesis. The solver uses the circuit structure of the problem to guide variable decisions. The solver can converge to a solution faster for both satisfiable and unsatisfiable instances. The input to the SAT solver may comprise ISA instruction types, microarchitectural states and ordering, relation placement rules such as power consumption relations, communication relations, microarchitectural happens-before relation and a set of relations of interest (e.g., set of relations that may be indicative of power side channel leakage). Leverage SAT solver to comprehensively explore space of possible program executions and their expected power consumption impacts. This space exploration enables automated synthesis of power litmus test suites based on the formal construct wherein an output of executing the executable code comprises the power consumption result of the hardware-representative system at the microarchitectural level. The executable code for these synthesized programs, i.e. the power litmus test suites, may be generated using tools like MicroProbe to then run on the target system and determine the power leakage metric value. The executable codes are small test counterexamples composed of instruction sequences that are likely to be distinguishable via power observations (i.e., power side channel leakage potential). A counterexample could determine whether a power side channel of the hardware representative system exists.

At step 640, the system executes power litmus tests on design and determine data on power consumption during test and evaluate leakage potential for design based on chosen metric at step 645. For example, a metric for measuring information leakage called the Side channel Vulnerability Factor (SVF) may be used in the evaluation. Other existing or future metrics that indicate vulnerability to side channels may also be used.

SVF is based on an observation that all side-attacks ranging from physical to microarchitectural rely on recognizing leaked execution patterns. SVF quantifies patterns in attackers'observations and measures their correlation to the victim's actual execution patterns and in doing so captures a system's vulnerability to side channel attacks. SVF measurements help expose unexpected vulnerabilities in whole-system designs and shows how designers can make performance-security trade-offs. Thus, SVF provides a quantitative approach to secure computer architecture.

In examples, using a provided instruction bound and any other synthesis criteria (e.g., any program execution involving power relations vs. specified power relations only), the system here will automatically synthesize executable code with instruction sequences that when executed may output power consumption result over time that can be indicative of information about the circuit itself (i.e., the circuit may be vulnerable to power side channel analysis). In embodiments, the system may execute the synthesized executable code a result of which a power consumption result may be extracted comprising power consumption of each instruction/operand as well as a power consumption differences of computing from one operand to another (e.g. add operand to multiply operand). The power consumption result may also comprise a Hamming distance between the current data value and a reference state, meaning the number of bits that differ between the two values; essentially, the more bits that flip, the higher the power consumption.

In another embodiment, the system may determine the power leakage metric according to a correlation between the power consumption result and a reference metric. For example, the system may calculate a similarity measure between the power consumption result and a SVF metric. In another example, performing a correlation determination comprises computing a power leakage probability according to power consumption results of a set of instructions such as by computing a probability by performing a similarity measure analysis of the power consumption results against the SVF metric.

At step 655, an iteration on design is performed to reach desired security. For example, at this step, an evaluation is performed whether the power leakage metric has reached the security threshold such as whether power leakage probability is above the threshold. ISA design change examples may comprise adding noise to make power consumption appear the same between multiply and square ops; Include temp register that is populated with new value that counteracts Hamming distance changes in operands. In another example, microarchitecture design change may comprise adding noise to an ALU when instruction queue indicates order that will lead to power changes and/or pre-fetching to avoid cache misses so that power changes between hits and misses are not as easily associated with program structure. If the security threshold is not reached 660, steps 615 and 620 are repeated.

If the security threshold is reached 665, at step 670, the system may validate design security using a known cryptographic algorithm to check for leakage. For example, the system may validate that the final design is secure against a power side channel by checking if a secret key is extractable from a power side channel while running a known cryptographic algorithm on the hardware representative system. If the validation fails, step 610 may be repeated.

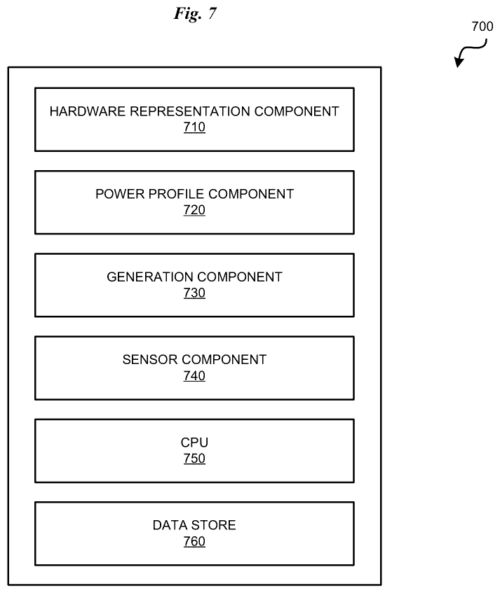

FIG. 7 depicts a system diagram that illustrates an example system for determining power side channels in semiconductor architecture and microarchitecture system in accordance with an illustrative embodiment. In a particular embodiment, the components of the diagram show aspects of the components of FIGS. 1-6.

In the illustrated embodiment, a power side channels in semiconductor architecture and microarchitecture system may comprise a network component, a hardware representative component 710, a power profile component 720, a generation component 730, a sensor component 740, a data store, a graphical processing unit (GPU) and a central processing unit (CPU) 750. For example, the network component may comprise a network adaptor, a socket, a graphics card, one or more routers, switches, hubs, and/or other network connectivity devices. The network component may transmit and/or receive data via network links such as data may be transmitted and/or received using Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet Protocols (TCP/IP), or other protocols and/or systems suitable for transmitting and receiving data. Data may be transmitted and/or received wirelessly or may utilize cabled network connections or telecom connections such as an Ethernet RJ45/Category 5 Ethernet connection, a fiber connection, a traditional phone wireline connection, a cable connection or other wired network connection.

In embodiments, the hardware representative system 710 may be constructed from standard, well-known techniques including combining standard module interfaces and buses, small amounts of glue logic, and I/O buffers to connect the devices into a single hardware system description. The processor and device descriptions are combinations of HDL descriptions and hard pre-designed and pre-verified components used in the creation of semiconductor chips or integrated circuits (ICs) cores representing physical layouts on a chip. The hardware representative system 710 may further comprise a software tool that may consist of conventional logic synthesis tools, layout tools, and fabrication tools that take the hardware description language (HDL) hardware system description and produces a physical design in the form of a semiconductor chip or multiple semiconductor chips. The system tool may also consist of conventional schematic capture tools, netlist tools, layout tools, fabrication tools, and assembly tools that take the schematic hardware system description and produce a physical design in the form of a printed circuit board populated with semiconductor chips.

In some embodiments, a sensor 740 used to measure a semiconductor's “side channel” may comprise an electromagnetic (EM) probe which detects the minute electromagnetic radiation emitted by the chip during operation, allowing analysis of its internal state and potential vulnerabilities related to side channel attacks; this is often used in conjunction with specialized equipment to capture and analyze the signals effectively.

A physical data storage device is the underlying technology behind a data store 760. The data store may comprise formats such as files, tables, or blocks stored on a device. The device can be local, remote, or in the cloud. Large data stores are typically distributed across multiple physical devices in different geographic locations. Software systems and services abstract the underlying operations of the data store. Different types of data storage devices provide varying degrees of security and redundancy. A solid-state drive (SSD) is a semiconductor technology that allows the writing and reading of data in flash memory chips. Flash storage technology was commercially available in pen drives before becoming an alternative to hard disk drives (HDD). Compared to an HDD, a physical SSD has no moving parts, which means it has faster performance and a longer lifespan. Hybrid storage array is a physical storage setup that consists of an SSD and an HDD. While an SSD offers a low-latency operation, it costs much more per-unit storage than an HDD. Therefore, organizations use a hybrid storage array to balance performance, capacity, and cost. RAID stands for a redundant array of independent disks. It is a technology that keeps the same data in multiple places on an SSD.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
determining a power consumption result of a hardware representative system comprising:
constructing a power consumption relation based in part on an instruction; and
generating executable code based on the power consumption relation wherein an output of executing the executable code comprises the power consumption result of the hardware representative system.

2. The computer-implemented method of claim 1, wherein the power consumption relation is based on a power consumption difference during an operand change.

3. The computer-implemented method of claim 1, wherein constructing the power consumption relation comprises the power consumption relation according to a microarchitecture of a hardware system.

4. The computer-implemented method of claim 1, wherein the hardware representative system represents a pre-silicon hardware and wherein the executable code is used to adjust a design of the pre-silicon hardware.

5. The computer-implemented method of claim 1, wherein generating executable code uses a Boolean satisfiability solver to generate the executable code wherein the executable code is a counterexample that determines whether a power side channel of the hardware representative system exists.

6. The computer-implemented method of claim 1, wherein the power consumption result outputted by executing the executable code comprises a power consumption of an architecturally defined instruction.

7. The computer-implemented method of claim 1, further comprising constructing the power consumption relation according to an operand of the instruction.

8. A computer program product comprising one or more computer readable storage media, and program instructions collectively stored on the one or more computer readable storage media, the program instructions executable by a processor to cause the processor to perform operations comprising:
determining a power consumption result of a hardware representative system comprising:
constructing a power consumption relation based in part on an instruction; and
generating executable code based on the power consumption relation wherein an output of executing the executable code comprises the power consumption result of the hardware representative system.

9. The computer program product of claim 8, wherein the power consumption relation is based on a power consumption difference during an operand change.

10. The computer program product of claim 8, wherein constructing the power consumption relation comprises the power consumption relation according to a microarchitecture of a hardware system.

11. The computer program product of claim 8, wherein the hardware representative system represents a pre-silicon hardware system and wherein the executable code is used to adjust a design of the pre-silicon hardware.

12. The computer program product of claim 8, wherein generating executable code uses a Boolean satisfiability solver to generate the executable code wherein the executable code is a counterexample that determines whether a power side channel of the hardware representative system exists.

13. The computer program product of claim 8, wherein the power consumption result outputted by executing the executable code comprises a power consumption of an architecturally defined instruction.

14. The computer program product of claim 8, further comprising constructing the power consumption relation according to an operand of the instruction.

15. A computer system comprising a processor and one or more computer readable storage media, and program instructions collectively stored on the one or more computer readable storage media, the program instructions executable by the processor to cause the processor to perform operations comprising:
determining a power consumption result of a hardware representative system comprising:
constructing a power consumption relation based in part on an instruction; and
generating executable code based on the power consumption relation wherein an output of executing the executable code comprises the power consumption result of the hardware representative system.

16. The computer system of claim 15, wherein the power consumption relation is based on a power consumption difference during an operand change.

17. The computer system of claim 15, wherein constructing the power consumption relation comprises the power consumption relation according to a microarchitecture of a hardware system.

18. The computer system of claim 15, wherein the hardware representative system represents a pre-silicon hardware system and wherein the executable code is used to adjust a design of the pre-silicon hardware.

19. The computer system of claim 15, wherein generating executable code uses a Boolean satisfiability solver to generate the executable code wherein the executable code is a counterexample that determines whether a power side channel of the hardware representative system exists.

20. The computer system of claim 15, further comprising constructing the power consumption relation according to an operand of the instruction.

21. A computer-implemented method comprising:
determining a power leakage metric of a hardware representative system comprising:
extracting a power consumption result of an instruction of the hardware representative system according to an output of executing code based on a power consumption relation of the instruction; and
determining the power leakage metric according to a correlation between the power consumption result and a reference metric.

22. The computer-implemented method of claim 21, wherein determining the power leakage metric further comprises computing a power leakage probability according to power consumption results of a set of instructions.

23. The computer-implemented method of claim 21, the reference metric is based on a side channel vulnerability factor.

24. A computer-implemented method comprising:
determining a power leakage metric of a hardware representative system comprising:
extracting a power consumption result of an instruction of the hardware representative system based on an output of executing code based on a power consumption relation of the instruction;
determining the power leakage metric according to a correlation between the power consumption result and a reference metric; and
adjusting an architecture and a microarchitecture of the hardware representative system according to the power leakage metric.

25. The computer-implemented method of claim 24, further comprising validating that the hardware representative system is secure against a power side channel leakage by determining if a secret key is extractable from a power side channel while executing a known cryptographic algorithm on the hardware representative system.
